(19) United States
(12) Patent Application Publication
(10) Pub. No.: US 2016/0235248 A1
(43) Pub. Date: Aug. 18, 2016

(54) VISUAL TEMPERATURE INDICATOR CONTAINER AND METHOD

(71) Applicant: CARLISLE FOODSERVICE PRODUCTS, INCORPORATED, Oklahoma City, OK (US)

(72) Inventors: Martin Ray Benning, Edmond, OK (US); Jillian Marie Moore, Edmond, OK (US); Bradley Alan Tilman, Oklahoma City, OK (US); Nancy Ann Voorhees, Maineville, OH (US)

(21) Appl. No.: 15/028,274

(22) PCT Filed: Oct. 13, 2014
(86) PCT No.: PCT/US14/60292

§ 371 Date: Apr. 8, 2016

Related U.S. Application Data
(60) Provisional application No. 61/890,565, filed on Oct. 14, 2013.

(51) Int. Cl. A47J 41/00; B65D 81/38

(52) U.S. Cl. CPC A47J 41/0094; A47J 41/0077; B65D 81/382; B65D 81/3816

(57) ABSTRACT

A container for maintaining human edible contents carried therein at a reduced temperature for an extended period of time is disclosed. The container is configured to have a first appearance and a second appearance and transitions between the first and second appearances at a predetermined temperature to provide a visual indication of the temperature of the container and the contents therein.

### CROSS-REFERENCE TO RELATED APPLICATION

This application claims the benefit of priority to U.S. Provisional Application No. 61/890,565 filed Oct. 14, 2013, the entirety of which is incorporated herein by reference.

### BACKGROUND

Many foods and other items for human consumption must be kept below a certain temperature to prevent spoilage or contamination. For containers carrying such items, this often becomes a guess-and-check process. One method is to physically insert a thermometer into the contents and check a thermometer from time to time. However, such method is impractical as the thermometer may be inadvertently removed or failed to be monitored. Another method is to set a timer when the container was put in use. However, this method is also imprecise as (i) the timer fails to get set; (ii) the timer is ignored; or (iii) the contents within the container may still be viable for consumption and are prematurely removed as a result of a timer being arbitrarily set.

Other methods to keep the container cool may include surrounding the container with ice. Such a method may be impracticable for the end-use of the container or potentially creating a mess or other hazard as a result of the ice melting.

### SUMMARY

A method comprising providing, in a room temperature environment, a container having a second appearance configured to carry human edible contents therein. The container configured to provide a visual temperature indication thereon, the container configured to reversibly transition between a first appearance and the second appearance, wherein the container includes an inner shell configured to carry the human edible contents therein and an outer shell having a thermochromic resin additive surrounding said inner shell and integrally connected to the inner shell. The container also includes a cavity defined between the inner shell and the outer shell, and a gelatinous material within the cavity positioned between the inner shell and the outer shell, wherein the gelatinous material is configured to maintain the container below a predetermined temperature for an extended period of time.

The method further includes visually inspecting the container for changes of the container from the second appearance to the first appearance and repeating the visually inspecting step one or more times. The method also includes removing the container when approximately eighty-five percent (85%) to about ninety-five percent (95%) of the visible outer shell is the first appearance.

A visual temperature-indicating container is also disclosed. The container comprises an inner shell configured to carry human edible contents therein and an outer shell surrounding said inner shell and integrally connected to the inner shell. The container also includes a cavity defined between the inner shell and the outer shell, an insulation layer within the cavity and proximate to the outer shell, and a gelatinous material within the cavity positioned between the inner shell and the insulation layer, wherein the gelatinous material is configured to maintain the container below a predetermined temperature for an extended period of time. The outer shell of the container includes a thermochromic resin additive and the outer shell is configured to have a first appearance or a second appearance. The outer shell is configured to change between the first and second appearances upon reaching and exceeding the predetermined temperature, and wherein the first and second appearances provide a visual temperature indication of the container, and wherein the first appearance and second appearance are different.

### BRIEF DESCRIPTION OF THE DRAWINGS

FIG. 1 depicts one embodiment of a container.

FIG. 2 shows a cross-sectional view of the container.

FIGS. 3A and 3B depict another embodiment of a container having visual temperature indicator on the outer shell.

FIG. 4A depicts another embodiment of container having a clear shell and a visual temperature indicator within a gel material having a second appearance.

FIG. 4B depicts FIG. 4A wherein the gel material has a first appearance.

FIG. 4C depicts another embodiment of a visual temperature-indicating container having thermochromic indicia thereon.

FIG. 5A depicts containers having a first appearance.

FIG. 5B depicts containers having second appearance.

FIGS. 5C-5L depict containers at various time intervals to illustrate the first and second appearances and transition therebetween.

FIG. 6 depicts a temperature graph of the contents within the containers depicted in FIGS. 5A through 5L at half hour time intervals.

### DETAILED DESCRIPTION

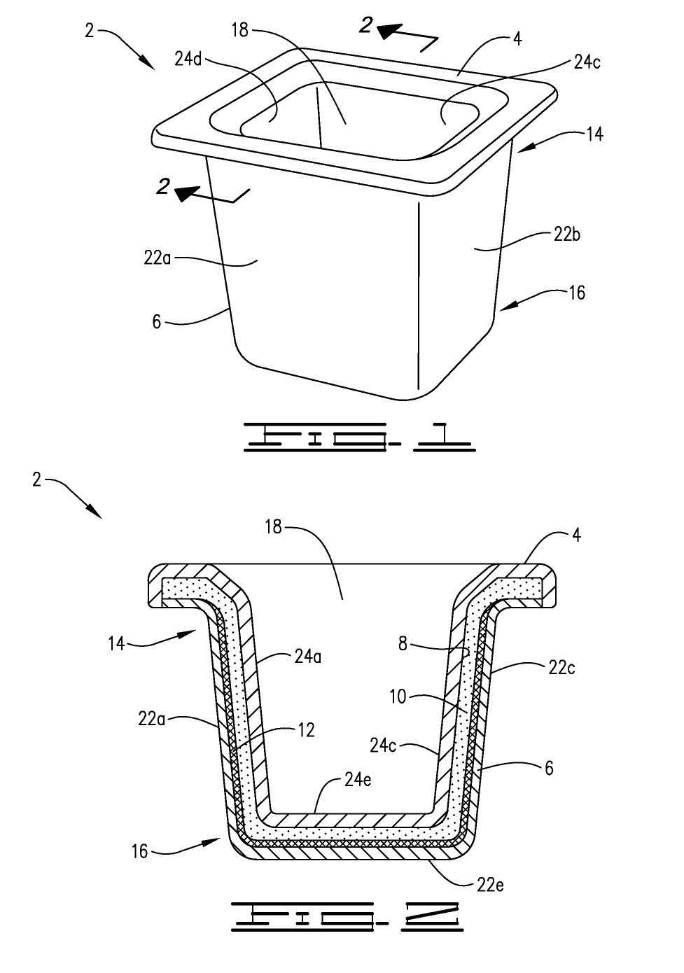

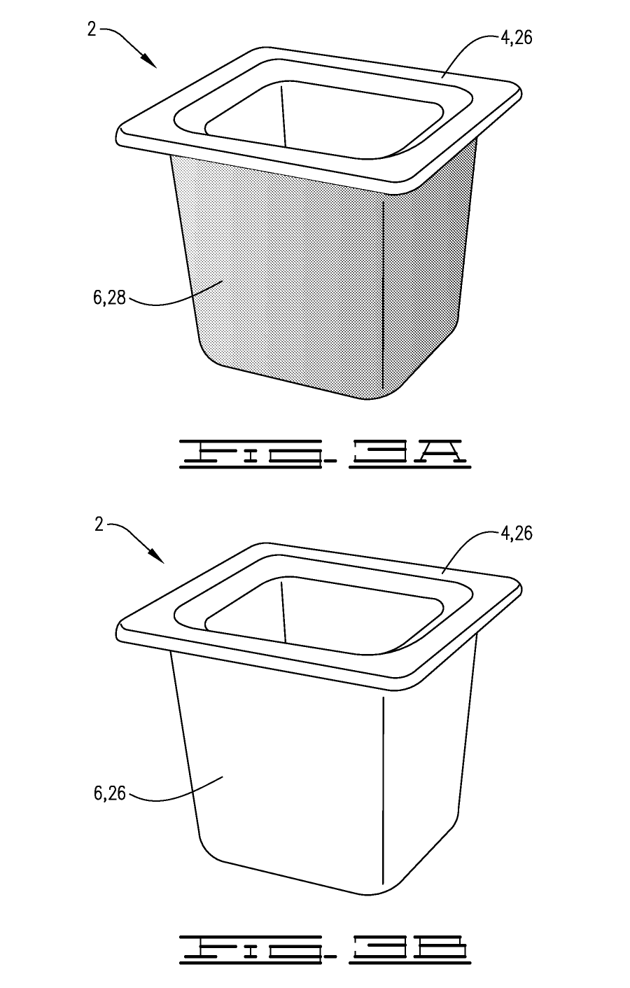

With reference to FIG. 1, container 2 includes an inner shell 4 configured to carry human edible contents therein. Container 2 also includes an outer shell 6 surrounding inner shell 4 and integrally connected to inner shell 4. As shown in FIGS. 1 and 2, inner shell 4 includes inner shell walls 24a, 24b, 24c, 24d, 24e. Specifically, inner shell 4 includes a bottom wall 24e and four side walls 24a, 24b, 24c, 24d integrally connected to bottom wall 24e. Each side wall extends upwardly from bottom wall 24e and each side wall is integrally connected to adjacent side walls, e.g. side wall 24a is adjacent to side wall 24b and 24d. The upper portion 14 of inner shell 4 defines an open end 18. Open end 18 extends down to lower portion 16 toward bottom wall 24e. As shown in FIG. 2, container 2 is configured to receive and carry fluid or solid items through open end 18, for example human edible contents or other small containers.

Outer shell 6 includes outer shell walls 22a, 22b, 22c, 22d, and 22e corresponding to inner shell walls 24a, 24b, 24c, 24d, and 24e. Specifically, outer shell 6 includes a bottom wall 22e and four side walls 22a, 22b, 22c, 22d integrally connected to bottom wall 22e. Each side wall extends upwardly from bottom wall 22e and each side wall is integrally connected to adjacent side walls, e.g. side wall 22a is adjacent to side wall 22b and 22d.

As shown in FIG. 2, container 2 also includes a cavity 8 defined between inner shell 4 and outer shell 6. Container 2 also includes a gelatinous material 10 within cavity 8. Gelatinous material 10 is positioned between inner shell 2 and outer shell 6. Gelatinous material 10 is configured to maintain container 2 below a predetermined temperature for an extended period of time. Gelatinous material 10 has slow-to-freeze, slow-to-thaw properties, and preferably is a blend of amorphous natural high-polymer carbohydrates comprising long chains of glucose rings hooked together by oxygen bridges containing the univalent group OH. A highly enzymatic resistance in the final formulation of gelatinous material 10 is desirable. To prevent leakage of gelatinous material 10 and damage to container 2, gelatinous material 10 may be kept within a bag (not depicted) or other containment device within cavity 8.

In some embodiments, for example, as shown in FIG. 2, container 2 may also include an insulation 12 within cavity 8. Insulation layer 12 is proximate to outer shell 6. For embodiments with insulation layer 12, gelatinous material 10 is positioned within cavity 8 between inner shell 4 and insulation layer 12. Although not depicted in the figures, it should be appreciated that in other embodiments, insulation layer 12 may be omitted. Insulation layer 12, for example, is a closed-celled plastic foam, for example, closed-celled polyethylene.

During the manufacturing process, inner shell 4 and outer shell 6 may be molded separately and later joined together to create an integral coupling of inner shell 4 and outer shell 6. The union of inner shell 4 and outer shell 6 can be fitted together via snap fitting or any other method such that a seal, preferably a hermetic seal, between inner shell 4 and outer shell 6 is achieved.

Inner shell 4 and outer shell 6 are made of a plastic material. For example, polypropylene, acrylonitrile butadiene styrene (ABS), or any plastic or composite material that is safe for coming into contact with items intended for human consumption or ingestion. For example, inner shell 4 and outer shell 6 are made of a material selected from the group consisting of polypropylene, acrylonitrile butadiene styrene (ABS), or composite material that is safe for coming into contact with human edible contents.

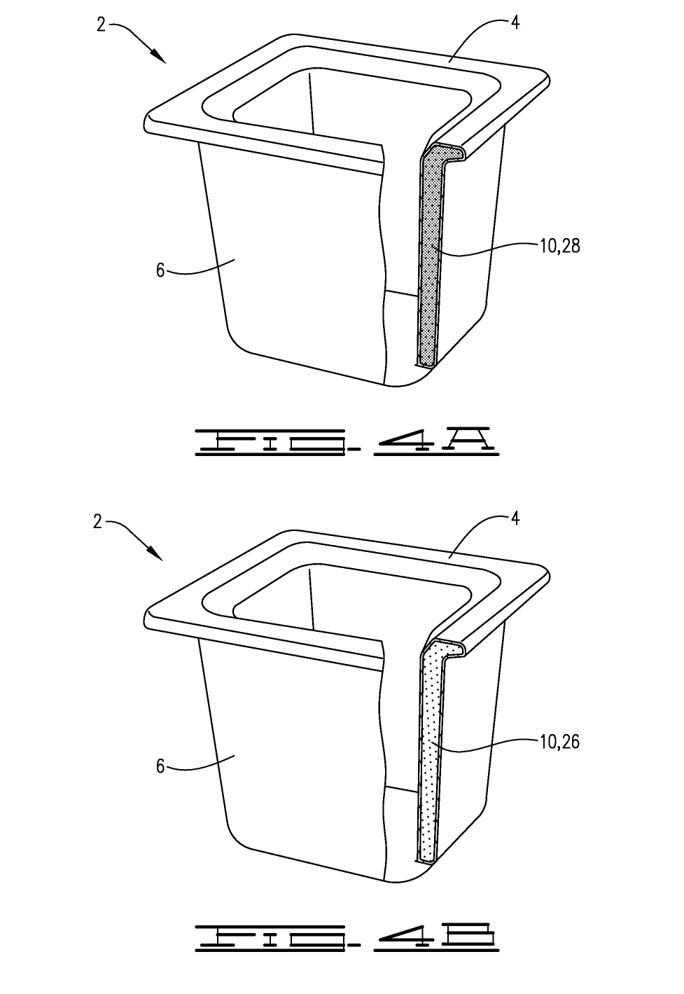

With reference to FIGS. 3A and 3B, outer shell 6 includes a thermochromic resin additive. Outer shell 6 is configured to change appearance between a first appearance 26 and a second appearance 28 upon reaching and exceeding the predetermined temperature. The first appearance 26 and second appearance 28 are different and first appearance 26 and second appearance 28 provide a visual temperature indication of container 2. Container 2 is configured to reversibly change appearance between first appearance 26 and second appearance 28.

The thermochromic resin additive is formulated to change color at a predetermined temperature based on the intended use and/or known operating conditions for container 2.

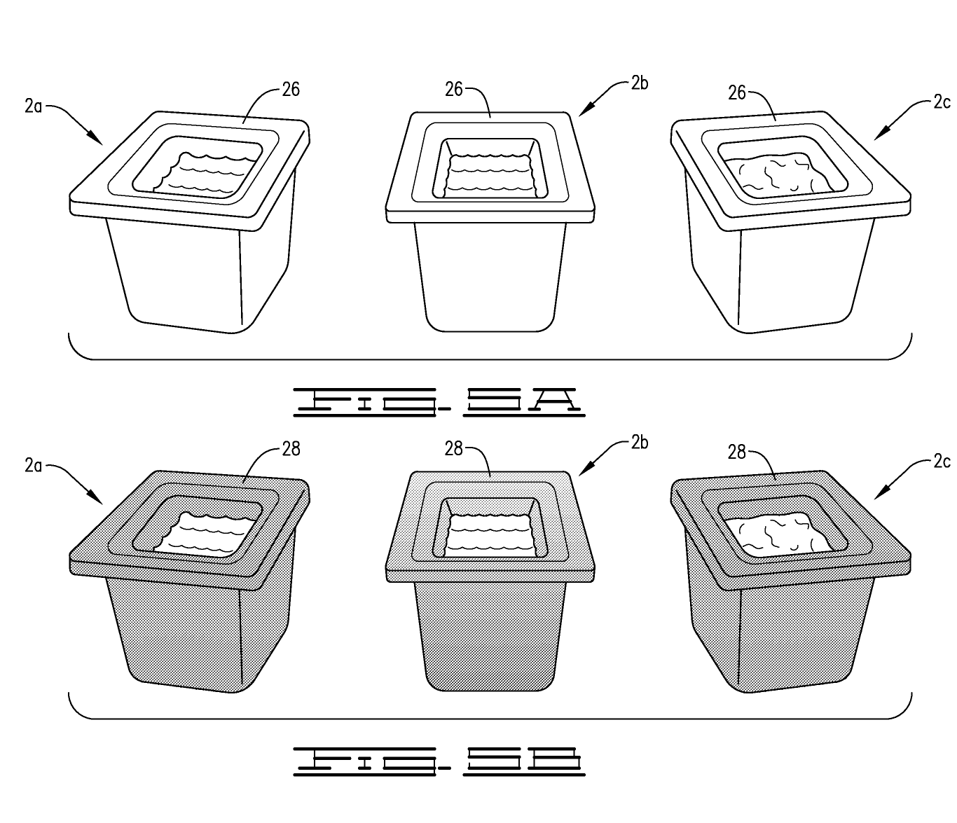

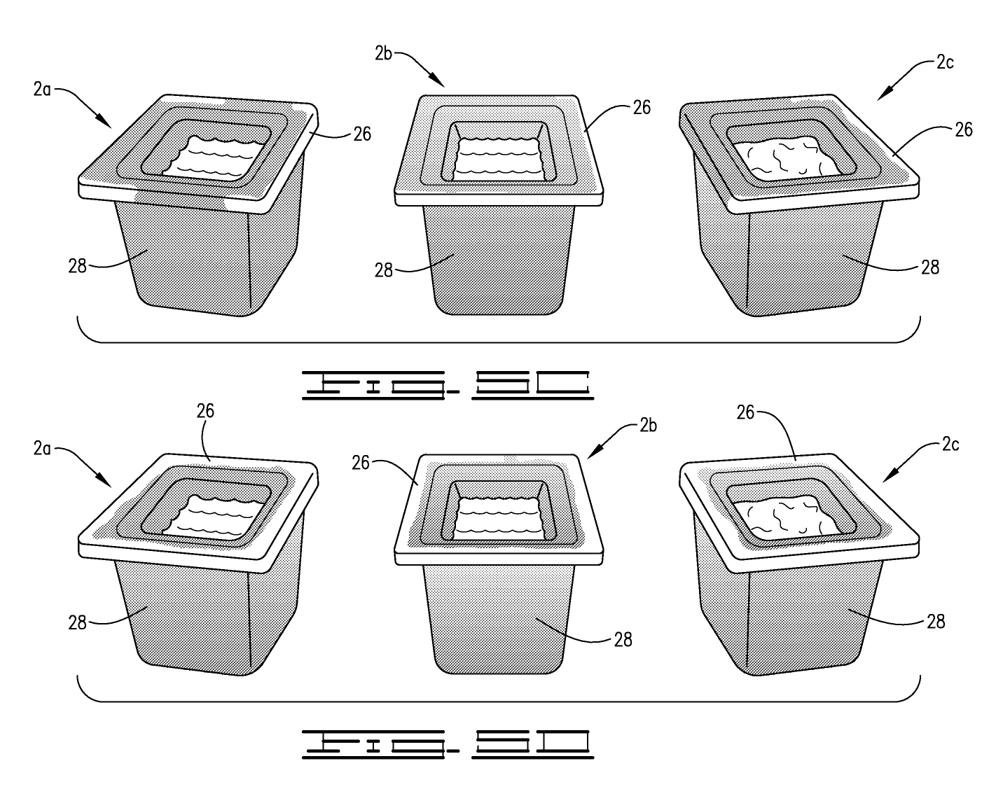

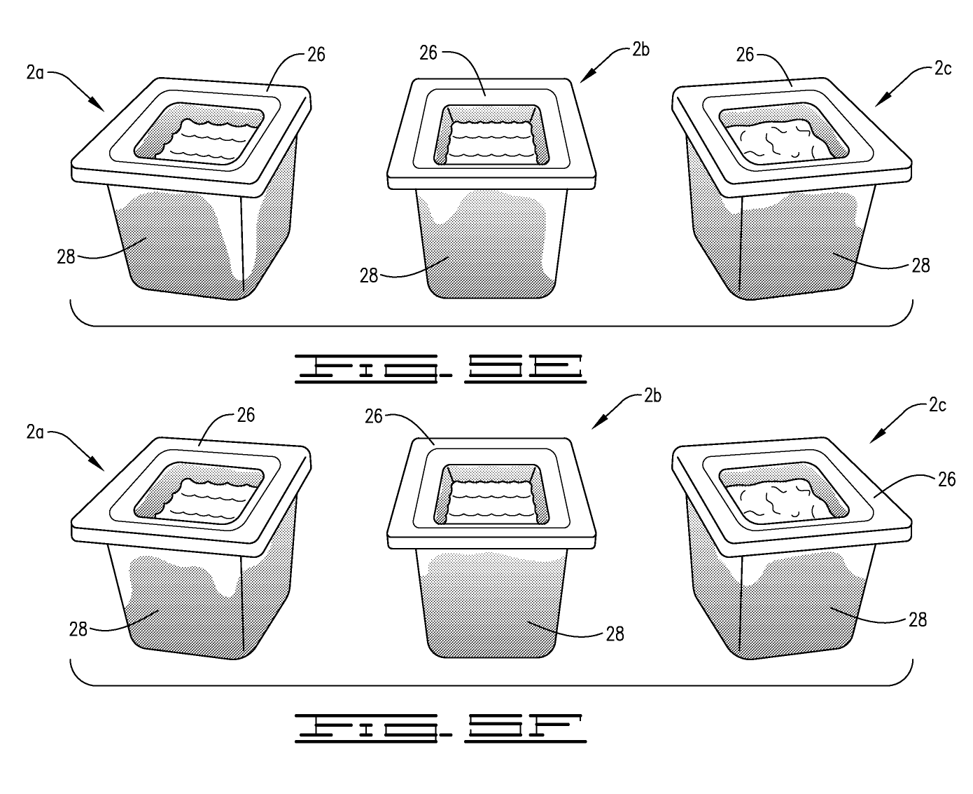

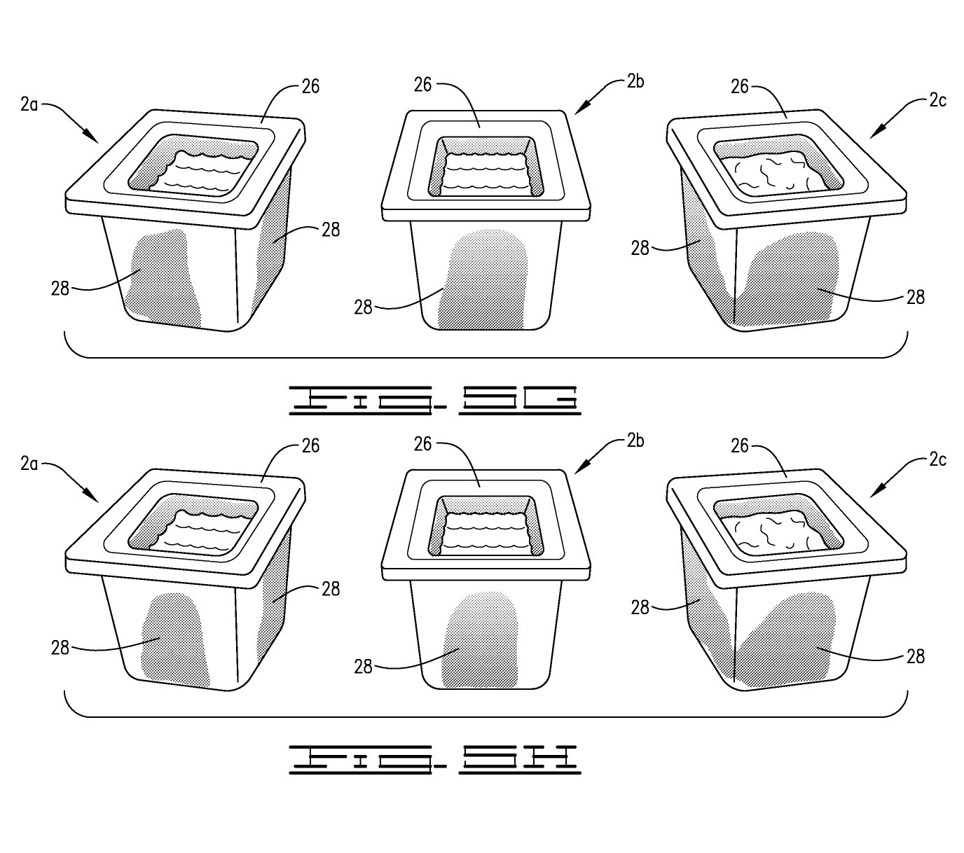

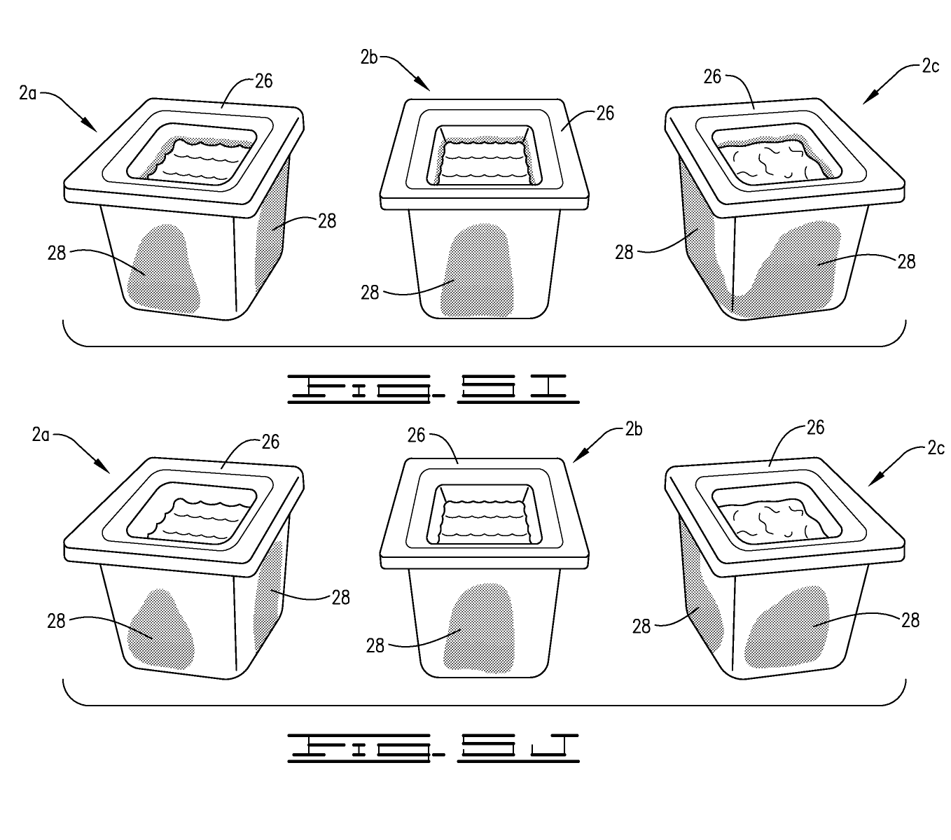

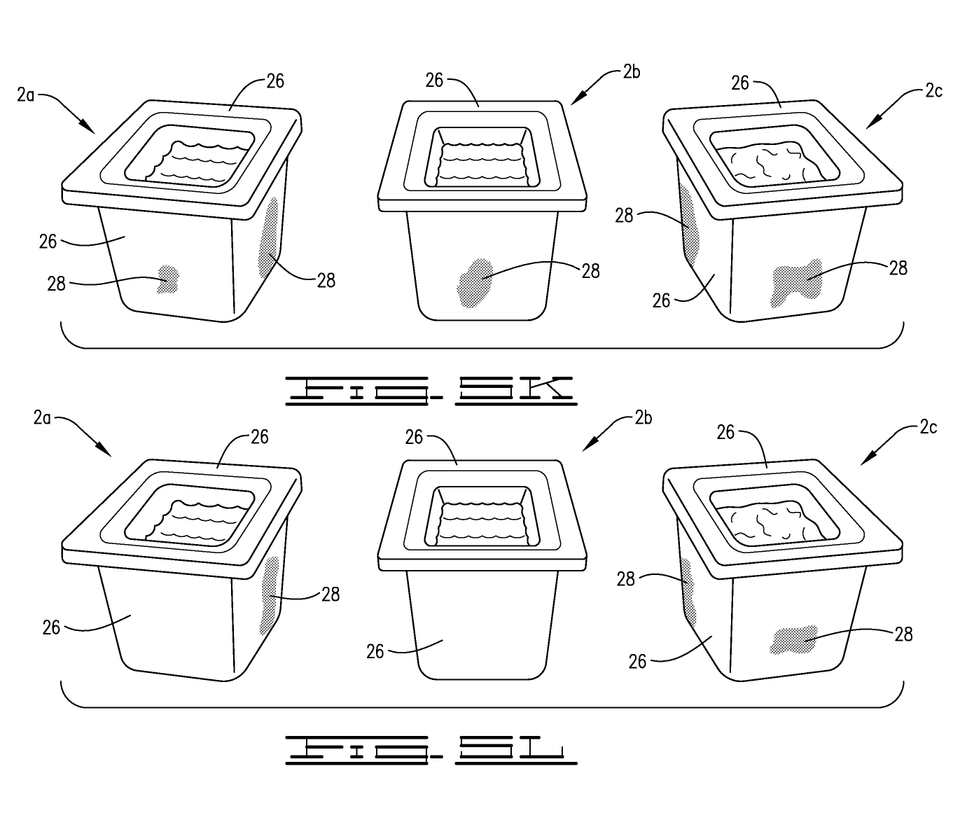

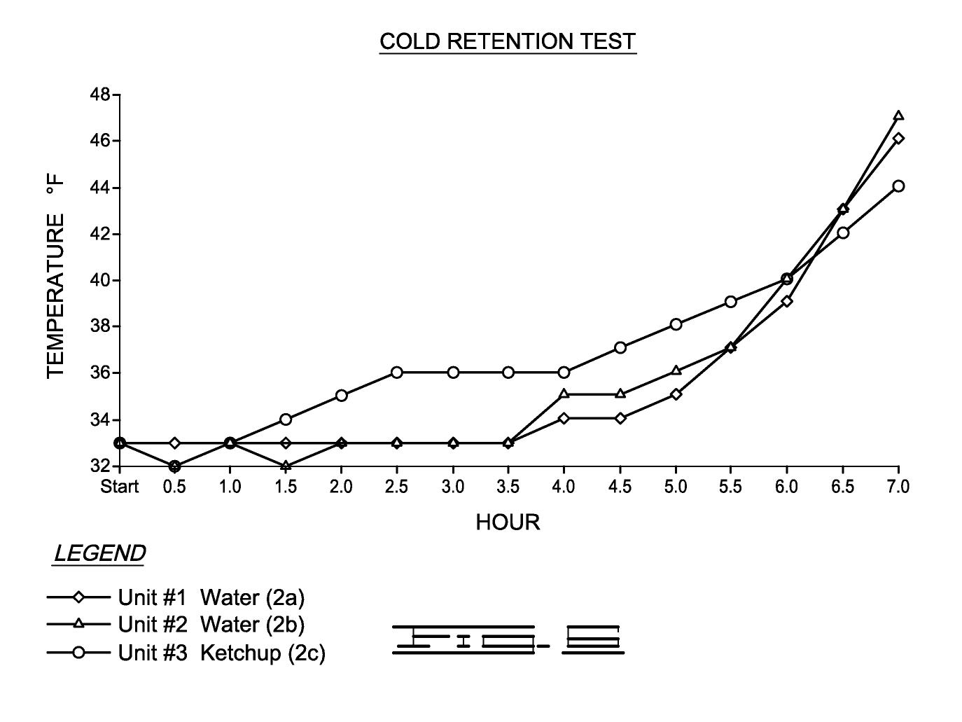

In the embodiment depicted in FIGS. 5A-5L, inner shell 4 and outer shell 6 of container 2 each include a thermochromic resin additive. As described above with reference to outer shell 6, inner shell 4 is also configured to have either the first appearance 26 or the second appearance 28 and to change between the first and second appearances upon reaching and exceeding the predetermined temperature.

Any thermochromic resin additive is suitable for inner shell 4 and outer shell 6 such that the additive is of an appropriate concentration and formulation that is safe for coming in contact with items that may be ingested by humans. For example, the appropriate concentration and formulation that is safe for coming in contact with items that may be ingested by humans may be dictated per standards set by appropriate governmental and regulatory authorities, including but not limited to the Food and Drug Administration and foreign jurisdictional counterparts and equivalents. It should be appreciated that outer shell 6 does not contact the contents carried by inner shell 4 and, in some embodiments, may have a different concentration and formulation than that used in inner shell 4.

In other embodiments, various colors can be selected and/or the concentration type and formulation can be selected for coming in contact with items that will be ingested or consumed by humans. For example, for embodiments where both inner shell 4 and outer shell 6 include the thermochromic resin, inner shell 4 may have a different color and/or concentration or formulation of the thermochromic resin addition than that of outer shell 6.

For example, a container 2 kept in an environment where ambient temperatures range from approximately seventy degrees Fahrenheit (70° F.) to approximately 75° F. will take an extended period of time for gelatinous material 10 to thaw and thus, will keep the contents within container 2 cooler for a longer duration of time compared to a container kept in an environment where ambient temperatures range from approximately 85° F. to 90° F. Typical room temperature environments are where the ambient temperature ranges from approximately 70° F. to approximately 75° F., preferably from approximately 73° F. to approximately 75° F.

As shown in FIGS. 3B and 5A, container 2 is a first appearance 26. Upon being chilled, for example, placed in a freezer or other cold environment to freeze gelatinous material 10, container 2 will transition to a second appearance 28, as depicted in FIGS. 3A and 5B.

As container 2 and the contents therein begin to rise in temperature, the appearance of container 2, will gradually change from second appearance 28 to first appearance 26, where first appearance 26 and second appearance 28 are different. For example, first appearance 26 and second appearance 28 may be different colors. The change in appearance of the visible portions of outer shell 6 of container 2 provides a visual temperature indication of container 2 to an observer. This visual temperature indication provides the observer with information that container 2 and the contents therein have reached a predetermined temperature and the contents and container 2 should be removed from the environment. For example, when approximately eighty-five percent (85%) to approximately one-hundred percent (100%) the visible outer shell 6 surfaces return back to having a first appearance 26, preferably when approximately 85% to approximately ninety-five (95%) percent of the visible outer shell 6 surfaces return back to having a first appearance 26, is when container 2 should be removed from the environment as the container and contents therein have reached the predetermined temperature. For example, the predetermined temperature is about forty degrees Fahrenheit (40° F.). The removal of container 2 from the environment upon reaching the predetermined temperature is for freshness and safety concerns. The contents in container may spoil or pose a health risk to those consuming the contents contained therein after a period of time of the contents being at an elevated temperature or the contents may taste old, stale, or not fresh after a period of time at being at an elevated temperature.

A method of using the visual temperature-indicating container 2 is also disclosed. The method is depicted in FIGS. 5A-5L. The method includes providing, in a room temperature environment, a container 2 having a second appearance 28 configured to carry human edible contents therein. For example, the room temperature environment may range from approximately about 70° F. to approximately 75° F. For example, the room temperature environment may range from approximately about 73° F. to approximately 75° F.

The container 2 is configured to provide a visual temperature indication thereon and the container 2 configured to reversibly transition between a first appearance 26 and the second appearance 28. The container 2 includes an inner shell 4 configured to carry the human edible contents therein, an outer shell 6 having a thermochromic resin additive. Outer shell 6 surrounds inner shell 4 and is integrally connected to inner shell 4. Container 2 also includes a cavity 8 defined between the inner shell 4 and the outer shell 6, and a gelatinous material 10 within the cavity 8. The gelatinous material 10 is positioned between the inner shell 4 and outer shell 6. Gelatinous material 10 is configured to maintain the container 2 below a predetermined temperature for an extended period of time.

The method further includes the step of visually inspecting the container 2 for changes of the container from the second appearance 28 to the first appearance 26. The method also includes repeating the visually inspecting step one or more times. The step of visually inspecting the container can be done at regular or irregular time intervals.

The method further includes removing the container when approximately eighty-five percent (85%) to about ninety-five percent (95%) of the visible outer shell 6 is the first appearance 26. As previously explained, the return of container 2 to the first appearance 26 indicates that container 2 has reached the predetermined temperature. For example, the predetermined temperature is about forty degrees Fahrenheit (40° F.).

Prior the step of providing the container 2 in the room temperature environment, the method includes chilling the container 2 by subjecting the container to a temperature at or below thirty-two degrees Fahrenheit (32° F.) for a time sufficient to cause the gelatinous material 10 to freeze and cause the container 2 to fall below the predetermined threshold thereby causing the outer shell 6 to transition from the first appearance 26 to the second appearance 28.

For example, the to keep contents within container 2 cool, container 2 is placed in a freezer or other cool environment in order to freeze gelatinous material 10 therein. The time sufficient to cause the gelatinous material 10 to freeze is approximately six hours to approximately eight hours. After gelatinous material 10 is frozen, container 2 keeps any contents therein cool for extended periods of time, for example, six hours or longer.

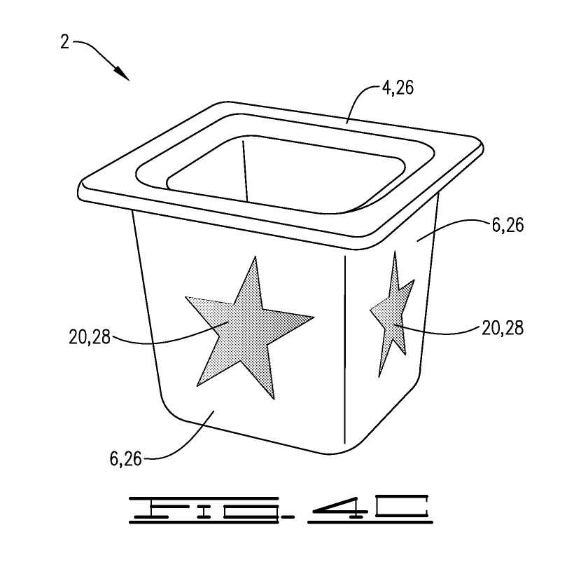

The above description has described different embodiments of where a thermochromic resin additive is included in either outer shell 6 or inner shell 4 or both. With reference to FIGS. 4A and 4B, another embodiment for container 2 includes the use of a thermochromic pigment in gelatinous material 10, and gelatinous material 10 is configured to reversibly transition between first appearance 26 (depicted in FIG. 4B) and second appearance 28 (depicted in FIG. 4A). For this embodiment, the bag or containment device holding gelatinous material 10 within cavity 8 is transparent. Either inner shell 4, or outer shell 6, or both inner shell 4 and outer shell 6 may be made of clarified ABS or other transparent material such that the gelatinous material 10 may be visually observed. In embodiments where outer shell 6 is transparent, insulation layer 12 may be removed.

Another embodiment for container 2 includes the use of thermochromic film. This embodiment is similar to the embodiment depicted in FIGS. 4A and 4B; however, in this embodiment the film bag containing gelatinous material 10 is configured to change between first appearance 26 and second appearance 28. Either inner shell 4, or outer shell 6, or both inner shell 4 and outer shell 6 are made of clarified ABS or other transparent material. In embodiments where outer shell 6 is transparent, insulation layer 12 may be removed.

FIG. 4C depicts another embodiment of container 2 through the use of thermochromic printing on outer shell 6. With reference to FIG. 4C, in this embodiment thermochromic indicia 20 is printed on outer shell 6. When the contents within container 2 are below a predetermined temperature, indicia 20 is visible as shown in FIG. 4C. In this embodiment, when the container 2 and the contents within container 2 are above the predetermined temperature, indicia 20 is not visible (not depicted), thus all walls of outer shell 6 are a first appearance 26, for example, as shown in FIG. 1. In another embodiment, not shown, indicia 20 may be visible at all times where first appearance 26 of indicia 20 is a first color and second appearance 28 of indicia 20 is a second color, wherein the first and second colors are different.

For all the other embodiments described above, the method of using the visual temperature-indicating container is substantially the same as previously described except for the changes to the container as described for each embodiment. Accordingly, for brevity, the method will not be repeated for each different embodiment of the container.

### Example

Included herein is an example of container 2, specifically three containers 2a, 2b, and 2c, having a thermochromic resin contained in both inner shell 4 and outer shell 6. In this example, a thermochromic resin additive of Chromocolor PS concentration green type number 10 from Matsui International Inc. was used in inner shell 4 and outer shell 6.

FIG. 5A depicts container prior to placement in a freezer and having a first appearance or first color 26. Container 2 was placed in a freezer for approximately eight hours. FIG. 5B depicts container 2 having the a second appearance or a second color 28 upon the removal from the freezer.

Contents were placed into containers 2a, 2b, and 2c. Container 2a, also referred to as Unit 1, contained chilled water. Container 2b, also referred to as for Unit 2, contained chilled water. Container 2c, also referred to as Unit 3, contained chilled ketchup. A thermocouple was placed in the middle of containers 2a, 2b, and 2c and was attached to a temperature data logger. Temperature readings were recorded every five minutes and the results of which are shown in Table 1. FIGS. 5C-5L depict the appearance of containers 2a, 2b, and 2c, at the varying time intervals corresponding to the temperature readings. In this example, the thermochromic resin additive used in container 2 was set to transition to and maintain second appearance 28 for temperatures below 40° F.

Containers 2a, 2b, and 2c were left undisturbed in a room temperature environment having ambient temperatures of approximately 73° F. to about 75° F. FIG. 6 depicts a graph of temperature readings for each container at half hour intervals.

As shown in FIG. 5C, after about five minutes from removal of containers 2a, 2b, and 2c from the freezer, the flange ends of inner shell 4 begin to transition back to first appearance 26. FIG. 5D depicts the containers ten minutes after removal and more visible surface area of inner shell 4 gradually transitioning back to first appearance 26.

FIG. 5E depicts containers 2a, 2b, and 2c after approximately thirty minutes from removal from the freezer wherein portions of inner shell 4 and outer shell 6 have transitioned back to first appearance 26.

FIGS. 5F, 5G, and 5H depict time intervals at one hour, two hours, and three hours, respectively. As shown in the figures, increasingly more surface area of containers 2a, 2b, 2c transition from second appearance 28 back to first appearance 26.

FIG. 5J depicts containers 2a, 2b, 2c, at the fifth hour time interval. As shown in FIG. 5J, patches having second appearance 28 remain visible on outer shell walls 22a and 22b.

At six hours, as shown in FIG. 5K, temperature readings for containers 2a, 2b, and 2c, were 39° F., 40° F., and 40° F., respectively. As shown in FIG. 5K, all containers show small patches having second appearance 28.

FIG. 5L depicts containers 2a, 2b, and 2c at the seven hour interval with over 90% of the exposed visible surface area of outer shell 6 returned to first appearance 26.

TABLE 1

| | Unit 1 -- | Unit 2 -- | Unit 3 -- |
|---|---|---|---|
| | Chilled | Chilled | Chilled |
| | Water | Water | Ketchup |
| Min/Hours | Temp (° F.) | Temp (° F.) | Temp (° F.) |
| 0 | 33 | 33 | 33 |
| 5 | 33 | 33 | 33 |
| 10 | 33 | 33 | 34 |
| 15 | 33 | 32 | 33 |
| 20 | 33 | 32 | 33 |
| 25 | 33 | 33 | 32 |
| 30 | 33 | 32 | 32 |
| 35 | 33 | 33 | 32 |
| 40 | 33 | 33 | 32 |
| 45 | 33 | 33 | 32 |
| 50 | 33 | 33 | 32 |
| 55 | 33 | 33 | 32 |
| 1 hour | 33 | 33 | 33 |
| 5 | 33 | 33 | 33 |
| 10 | 33 | 33 | 33 |
| 15 | 33 | 33 | 33 |
| 20 | 33 | 33 | 34 |
| 25 | 33 | 33 | 35 |
| 30 | 33 | 32 | 34 |
| 35 | 33 | 33 | 35 |
| 40 | 33 | 33 | 35 |
| 45 | 33 | 33 | 35 |
| 50 | 33 | 33 | 36 |
| 55 | 33 | 33 | 36 |
| 2 hour | 33 | 33 | 35 |
| 5 | 33 | 33 | 35 |
| 10 | 33 | 33 | 35 |
| 15 | 33 | 34 | 35 |
| 20 | 33 | 33 | 35 |
| 25 | 33 | 34 | 36 |
| 30 | 33 | 33 | 36 |
| 35 | 33 | 33 | 35 |
| 40 | 33 | 33 | 35 |
| 45 | 33 | 33 | 35 |
| 50 | 33 | 33 | 35 |
| 55 | 33 | 34 | 35 |
| 3 hour | 33 | 33 | 36 |
| 5 | 33 | 34 | 36 |
| 10 | 34 | 33 | 36 |
| 15 | 34 | 34 | 36 |
| 20 | 33 | 34 | 36 |
| 25 | 34 | 34 | 36 |
| 30 | 33 | 33 | 36 |
| 35 | 33 | 33 | 36 |
| 40 | 33 | 33 | 36 |
| 45 | 33 | 34 | 36 |
| 50 | 33 | 34 | 36 |
| 55 | 34 | 34 | 36 |
| 4 hour | 34 | 35 | 36 |
| 5 | 34 | 34 | 36 |
| 10 | 34 | 35 | 37 |
| 15 | 35 | 34 | 37 |
| 20 | 35 | 34 | 37 |
| 25 | 34 | 34 | 37 |
| 30 | 34 | 35 | 37 |
| 35 | 34 | 34 | 37 |
| 40 | 34 | 34 | 37 |
| 45 | 35 | 35 | 38 |
| 50 | 35 | 35 | 38 |
| 55 | 36 | 36 | 38 |
| 5 hour | 35 | 36 | 38 |
| 5 | 36 | 35 | 39 |
| 10 | 36 | 36 | 38 |
| 15 | 36 | 36 | 39 |
| 20 | 37 | 36 | 39 |
| 25 | 36 | 36 | 39 |
| 30 | 37 | 37 | 39 |
| 35 | 37 | 37 | 39 |
| 40 | 38 | 38 | 39 |
| 45 | 38 | 38 | 40 |
| 50 | 38 | 38 | 40 |
| 55 | 39 | 39 | 40 |
| 6 hour | 39 | 40 | 40 |
| 5 | 39 | 40 | 40 |
| 10 | 40 | 41 | 41 |
| 15 | 40 | 41 | 40 |
| 20 | 41 | 42 | 41 |
| 25 | 42 | 42 | 41 |
| 30 | 43 | 43 | 42 |
| 35 | 43 | 44 | 42 |
| 40 | 43 | 45 | 42 |
| 45 | 43 | 45 | 43 |
| 50 | 44 | 45 | 43 |
| 55 | 45 | 46 | 43 |
| 7 hour | 46 | 47 | 44 |

Container 2 can be of varying sizes and shapes such that the general description for keeping the contents therein for extended periods of time and having a temperature indication thereon are achieved.

Other embodiments, variations, and modifications of the presently described apparatus and method will be apparent to one skilled in the art. As such, the foregoing description merely enables and describes the general uses and methods of the described apparatus and method and should not be taken as limiting the scope of the claimed invention. Accordingly, the following claims and equivalents thereto are claimed as the invention.

What is claimed is:

1. A method comprising:
providing, in a room temperature environment, a container having a second appearance configured to carry human edible contents therein, the container configured to provide a visual temperature indication thereon, the container configured to reversibly transition between a first appearance and the second appearance, wherein the container includes
an inner shell configured to carry the human edible contents therein,
an outer shell having a thermochromic resin additive surrounding said inner shell and integrally connected to the inner shell,
a cavity defined between the inner shell and the outer shell, and
a gelatinous material within the cavity positioned between the inner shell and the outer shell, wherein the gelatinous material is configured to maintain the container below a predetermined temperature for an extended period of time;
visually inspecting the container for changes of the container from the second appearance to the first appearance;
repeating the visually inspecting step one or more times; and
removing the container when approximately eighty-five percent (85%) to about ninety-five percent (95%) of the visible outer shell is the first appearance.

2. The method of claim 1, further comprising:
prior the step of providing the container in the room temperature environment, chilling the container by subjecting the container to a temperature at or below thirty-two degrees Fahrenheit (32° F.) for a time sufficient to cause the gelatinous material to freeze and cause the container to fall below the predetermined threshold thereby causing the outer shell to transition from the first appearance to the second appearance.

3. The method of claim 2, wherein the time sufficient to cause the gelatinous material to freeze is approximately six to eight hours.

4. The method of claim 1, wherein the room temperature environment is approximately about seventy-three degrees Fahrenheit (73° F.) to about seventy-five degrees Fahrenheit (75° F.).

5. The method of claim 1, wherein the container includes an insulation layer within the cavity and proximate to the outer shell.

6. The method of claim 5, wherein the insulation layer is closed-cell plastic foam.

7. The method of claim 1, wherein the inner shell includes the thermochromic resin additive and the inner shell is configured to have the first appearance or the second appearance, wherein the inner shell is configured to change between the first and second appearances upon reaching and exceeding the predetermined temperature.

8. The method of claim 1, wherein the inner shell and the outer shell are made of a material selected from the group consisting of polypropylene, acrylonitrile butadiene styrene (ABS), or composite material that is safe for coming into contact with human edible contents.

9. The method of claim 1, wherein the predetermined temperature is about forty degrees Fahrenheit (40° F.).

10. A visual temperature-indicating container comprising:
an inner shell configured to carry human edible contents therein;
an outer shell surrounding said inner shell and integrally connected to the inner shell;
a cavity defined between the inner shell and the outer shell;
an insulation layer within the cavity and proximate to the outer shell; and
a gelatinous material within the cavity positioned between the inner shell and the insulation layer, wherein the gelatinous material is configured to maintain the container below a predetermined temperature for an extended period of time;
wherein the outer shell includes a thermochromic resin additive and the outer shell is configured to have a first appearance or a second appearance, wherein the outer shell is configured to change between the first and second appearances upon reaching and exceeding the predetermined temperature, and wherein the first and second appearances provide a visual temperature indication of the container, and wherein the first appearance and second appearance are different.

11. The visual temperature-indicating container of claim 10, wherein the inner shell includes a bottom wall and four side walls integrally connected to the bottom wall and each side wall extends upwardly from the bottom wall, and wherein each side wall is integrally connected to adjacent side walls, and wherein the outer shell includes a bottom wall and four side walls integrally connected to the bottom wall and each side wall extends upwardly from the bottom wall, and wherein each side wall is integrally connected to adjacent side walls.

12. The visual temperature-indicating container of claim 10, wherein the inner shell includes the thermochromic resin additive and the inner shell is configured to have the first appearance or the second appearance, wherein the inner shell is configured to change between the first and second appearances upon reaching and exceeding the predetermined temperature.

13. The visual temperature-indicating container of claim 10, wherein the inner shell and the outer shell are made of a material selected from the group consisting of polypropylene, acrylonitrile butadiene styrene (ABS), or composite material that is safe for coming into contact with items intended for human consumption.

14. The visual temperature-indicating container of claim 10, wherein the insulation layer is closed-cell plastic foam.

15. The visual temperature-indicating container of claim 10, wherein the predetermined temperature is about forty degrees Fahrenheit (40° F.).
